(19) United States
(12) Patent Application Publication
(10) Pub. No.: US 2026/0363175 A1
(43) Pub. Date: Nov. 19, 2026

(54) COMB DISC SYSTEM FOR SOFT CATCHING OF FRUITS IN A MECHANIZED FRUIT PICKER

(71) Applicants: Momcilo KOKANOVIC, Obrenovac (RS); Marko KOKANOVIC, Obrenovac (RS); Miodrag KOKANOVIC, Obrenovac (RS); Filip KOKANOVIC, Obrenovac (RS)

(72) Inventors: Momcilo KOKANOVIC, Obrenovac (RS); Marko KOKANOVIC, Obrenovac (RS); Miodrag KOKANOVIC, Obrenovac (RS); Filip KOKANOVIC, Obrenovac (RS)

(21) Appl. No.: 19/154,386

(22) PCT Filed: Feb. 6, 2024
(86) PCT No.: PCT/RS2024/000002

§ 371 Date: Aug. 7, 2025

(30) Foreign Application Priority Data
Feb. 7, 2023 (RS) P-2023/0105

(51) Int. Cl. A01D 46/22

(52) U.S. Cl. CPC A01D 46/22

(57) ABSTRACT

A comb disc system for the soft catching of fruits in a mechanized fruit picker consists of two support beams (1.1) that serve as a link between a comb disc (4) and the structure of the machine itself, positioned on the left and right sides of a tunnel, thereby completely enclosing the space around a plant. Levers (3) of the comb disc are rotatably connected to the support beams (1.1), and their purpose is to bring the comb disc (4) into the optimal position for catching fruits. The rotating disc (4) consists of a body (4.1), a pivot (4.2) for rotation with a central channel, a catch cushion (4.4) made of rubber, fingers (4.5), and combs (4.6). The air supplied through an air channel (1.8) connected to a connector (1.4) for compressed air on the picker machine further passes through the lever (3), then through the channel of a pivot (4.2) for disc rotation, and forms a catch cushion (4.4) made of rubber that ensures a soft catch of the fruits.

### TECHNICAL FIELD

The subject invention broadly pertains to the field of fruit harvesting, specifically to devices for shaking trees or bushes, and more narrowly to the devices for fruit catching that are used in conjunction with them.

### TECHNICAL PROBLEM

The technical problem addressed by this invention relates to how to design a comb disc system for soft catching of fruits in mechanized fruit harvesting that would ensure better access to the plant and closing of open spaces around branches, thereby reducing the possibility of fruit spilling onto the ground while ensuring the system does not damage the fruit. The system is intended to be a cost-effective, reliable, and simple design solution for manufacturing, assembly, and maintenance with a long lifespan and economical viability.

### STATE OF THE ART

Based on the current state of the art, there are several solutions for catching harvested fruit, which can be divided into two groups. The first group includes solutions with rotating catch plates, with or without air cushions, among which is a solution disclosed in the Serbian patent. In the Serbian patent document number RS60564B1 titled “Pneumatic Cushions for Soft Catching of Harvested Fruit in a Mechanized Fruit Picker,” a device is disclosed that is placed on opposite sides of the tunnel of a mechanized fruit picker. It consists of rotatably mounted plates arranged in two rows on each side of the tunnel so that each plate overlaps with the adjacent plate in the same and opposite row. The plates are made of plastic, and an elastic membrane is peripherally attached to their upper side, forming an air cushion that provides a soft catch for the fruit. The membrane interior is connected via pneumatic conduits to the compressed air supply on the picker.

A similar solution is disclosed in the American patent document number US2011167778A1 titled “Crop catching apparatus and crop harvesting machine employing the same,” with the difference being that the plates do not have an air cushion but instead have air channels on the upper side through which air flows, providing a soft catch for the fruit.

Devices disclosed in the American patent document number US2019281764A1 titled “Berry harvester” operate on a similar principle, where the plates are frame-shaped, and a flexible material suitable for soft catching of fruit is stretched between the plates' sides. Also, the American patent document US2017238465A1 titled “Blueberry harvester and method of harvesting” features catching plates, and the American patent document number U.S. Pat. No. 5,647,194A titled “Elastomer closure spring” uses plates that are flexed with elastomeric blocks.

The Chinese patent document CN206760109U titled “A connect fruit board device that is used for little berry machinery to pick” also describes rotating levers arranged in a series with rotating discs located at the inner ends of the levers on both sides of the mechanized fruit picker's tunnel. Although the discs are made of soft and flexible PVC, they cannot provide a soft catch nor completely effectively close the free zone around the tree.

In all mentioned solutions that use relatively rigid plates, it has been observed that there is a need for their improvement in terms of effectively closing the free space around the tree as well as in terms of soft fruit catch for those solutions that do not use catch cushions.

Additionally, there are solutions that use catch brushes. The British patent document GB2604387A titled “Fruit tool collector and harvester” discloses a fruit-catching device that includes a longitudinal brush with two heads connected along the longitudinal axis so that the bristles extend outward, forming an angle between the two heads for collecting fruit. The fruit is collected by having one device pass on each side of a row of fruit trees, where the adjacent bristles overlap, thus reducing the open space and the possibility of fruit falling.

Similarly, the Soviet patent document SU1024031A1 titled “Berry picking machine collector” and the international patent application WO2020159371A1 titled “Harvesting device and method for harvesting fruit hanging from a plant” also describe longitudinal brushes that approach the row of trees from both sides to softly catch the fruit and completely close the space around each tree.

However, in all three previously described solutions, although the brush bristles are elastic so as to provide a soft catch for the fruits, they may not have sufficient stiffness to securely catch heavier fruits due to their relatively large length, which can lead to the fruits falling through. Additionally, due to their complexity, the brushes are relatively expensive to produce.

### DISCLOSURE OF INVENTION

The aforementioned drawbacks of the current state of the art are overcome by the subject invention, which relates to a comb disc system intended for catching fruits in tunnel fruit pickers. The system includes two essentially parallel opposite support beams such that each beam can be attached to one side of the tunnel of the mechanized fruit picker. For each beam, a series of evenly spaced comb disc levers are rotatably connected, elastically supported on the beam, with disc bodies rotatably connected at the inner end of each lever. The levers are positioned at an angle so that the inner ends of the levers are directed outward and upward, making the upper sides of the discs oriented upwards and outwards. This allows the fruits to be collected in the area of the tunnel side, e.g., via a belt conveyor. It should be noted that during fruit picking, the picker moves at a certain speed (it is not stationary). This leads to the free rotation of the comb discs caused by the contact between the plant and the levers, i.e., the discs moving in the opposite direction of the picker's movement. Also, due to the free rotation of the discs, the fruit is transferred to the conveyor belt.

In one embodiment, the ends of the beam are flexed over springs, preferably by two coil springs on each side and supports attached to the fruit picker machine. This allows the transmission of vibrations from the machine to the fruit-catching system, which, by its activation, leads to the forced transfer of fruits onto the catch belts.

Radially positioned fingers are firmly attached around the edge of the plate. Transversely and on each side of the finger, flexible combs are firmly attached, slightly angled upwards in relation to the longitudinal axis of the finger. To prevent overlapping of combs from adjacent fingers, the combs are longest at the outer end of each finger and then gradually decrease in length towards the inner end of the finger. At least some combs of each disc partially overlap with at least some combs of the same and opposite row of comb discs.

The use of rotating comb discs with flexible combs or bristles allows for both a soft catch of the fruit and effective closure of the open space between the combs and the tree, as well as secure and reliable retention of the fruit without spilling and falling to the ground. In addition, the system is simple to manufacture.

In one embodiment, the outer end of each lever is extended over the beam relative to the pivot joint, and the extension is elastically supported on the support beam by having one end of a tension spring rotatably connected to the end of the extended lever, while the other end of the tension spring is rotatably connected to the outer side of the beam. This allows the levers to lean on the trees as the picker machine passes through the orchard and encompasses the tree with the tunnel of the mechanized fruit picker.

At the outer end of each lever, a rotation limiter of the lever in relation to the beam is provided. It is preferable for the limiter to be perpendicular to the plane of lever rotation so that it can rest on the outer sides of the beam in two end positions.

The levers preferably have a system for tensioning or tightening the springs, which includes springs attached to the outer side of the beam via a tensioning profile with slotted holes through which the profile is firmly attached to the beam with screws through eyelets. In addition, the profile is at one end connected through an eyelet with a screw, to the eyelet of a tensioning screw firmly attached to the outer side of the beam. The tensioning system allows for levers to reliably rest around the trees, thus effectively closing the free space via the comb discs during the fruit-catching process.

According to another embodiment, a membrane attached to the upper side of the disc rim forms a catch cushion containing pressurized air, which further cushions the fall of fruit and onto the catch plates of the comb discs. It is preferable that a central opening be made in the middle of the disc body, which on its lower side is connected to a shaft with a channel firmly attached to the disc body, allowing the connection of the air cushion's interior and the air channel for connection to the compressed air supply on the picker machine, thus maintaining constant pressure in the air cushion. Even more preferably, the shaft with the channel is connected with the compressed air supply connector on the picker machine through the hollow section of the lever body, then the hollow shaft of the lever and the air channel placed on the beam, preferably on its lower side.

According to another embodiment, sleeves are radially and inseparably attached around the disc body rim. Into each sleeve, a finger is inserted and firmly attached, preferably via a bolt passed through coaxial slots made transversely to the finger and sleeve, ensuring secure fixation of the fingers with combs to the disc body.

In yet another embodiment, a longitudinal slot is made on each side of the finger into which combs are inserted and firmly attached. Alternatively, the fingers can be integrally made with combs, for example by casting.

The disc body can essentially have the shape of a polygon, most preferably a hexagon or octagon, or it can be circular.

### BRIEF DESCRIPTION OF THE DRAWING FIGURES

For a better understanding of the invention and to show how it can be implemented in practice, the applicant refers to the attached drawing where:

FIG. 1—shows the axonometric view of the assembly of the air tunnel of the picker with the comb disc system for a mechanized fruit picker.

FIG. 2—shows the axonometric view of the fruit-catching assembly using comb discs.

FIG. 3—a) shows the axonometric view of the support beam for the comb discs,
b) shows detail “A” from FIG. 3a),
c) shows the axonometric view of the support beam with bent ends,
d) shows detail “B” from FIG. 3c),
e) shows detail “C” from FIG. 3c),

FIG. 4—a) shows the axonometric view of the spring tensioner,
b) shows detail “B” from FIG. 4a),
c) shows detail “C” from FIG. 4a),

FIG. 5—shows the axonometric view of the lever of the comb discs,

FIG. 6—a) shows the top view of the rotating disc with combs,
b) shows the cross-section D-D from FIG. 6a),
c) shows the bottom view of the rotating disc with combs,

FIG. 7—a) shows the axonometric view of the cast finger with combs,
b) shows the axonometric view of the finger with channels for fixing the combs,
c) shows the finger with combs viewed from the front,
d) shows the cross-section E-E from FIG. 7c).

### DETAILED DESCRIPTION OF THE INVENTION

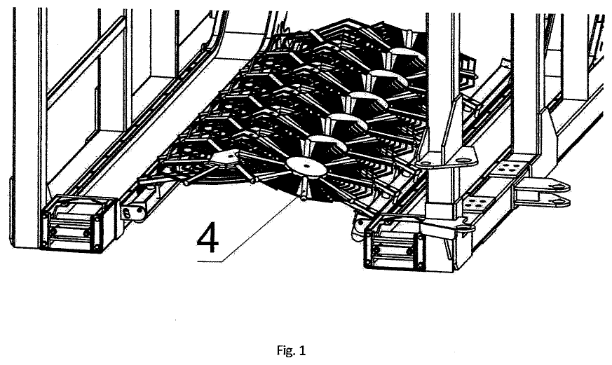

The subject invention relates to a comb disc system for the soft catching of harvested fruit in a mechanized fruit picker, whose construction is known from the invention and FIGS. 1 to 7. The system fundamentally consists of two supporting beams longitudinally positioned and of the same length with comb discs on the left and right sides of the picker tunnel, allowing for the complete closure of space around the plant. One beam is rotated at an angle relative to the other beam to avoid collision and ensure necessary overlap.

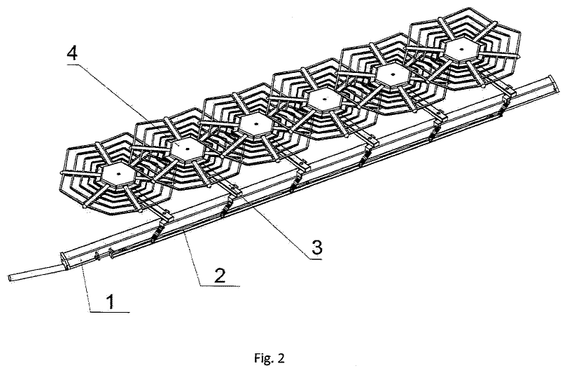

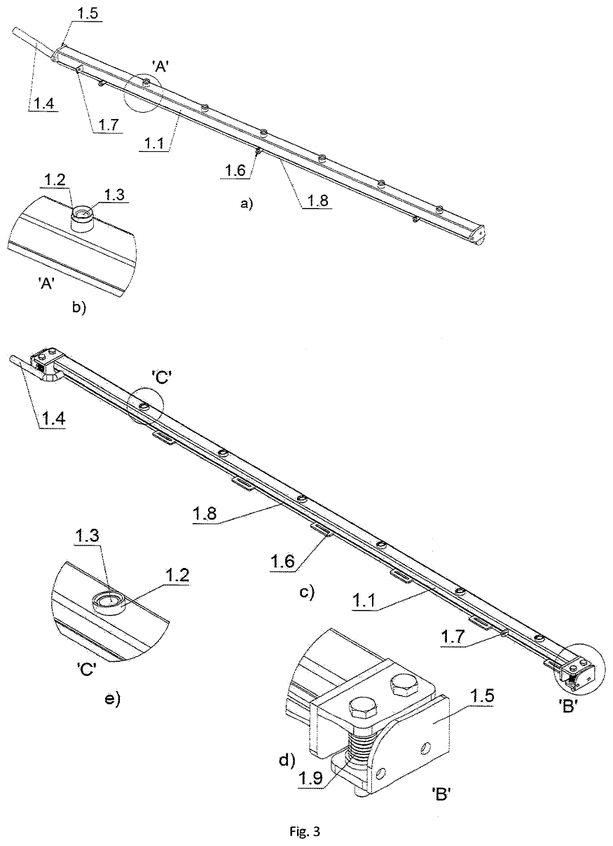

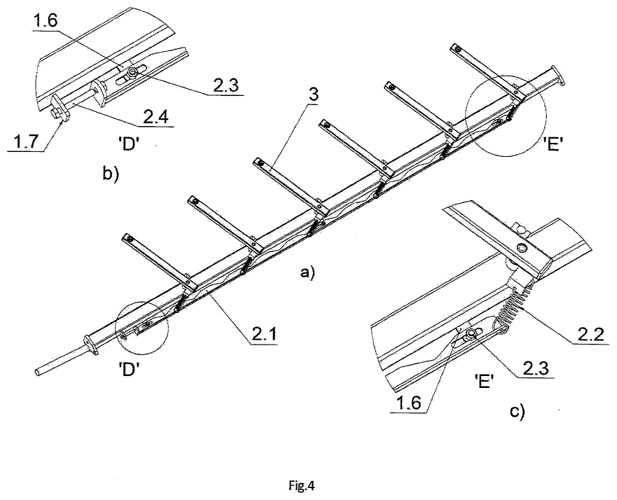

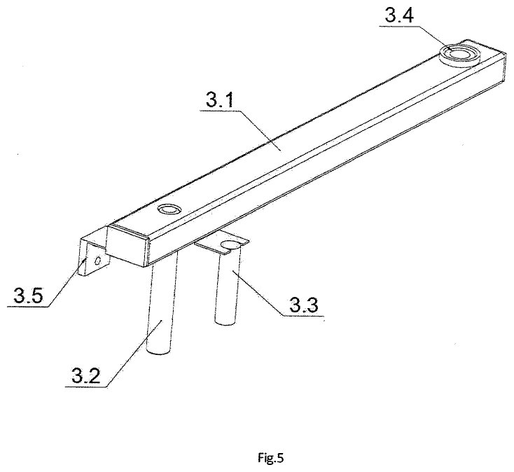

FIG. 2 shows the assembly of the comb disc system, which includes subassemblies of the support beam 1 for comb disc, tensioner 2 for springs, levers 3 for comb discs, and rotating disc 4 with combs.

The support beam 1.1 serves as a connection between the comb discs and the structure of the fruit picking machine itself, with the purpose of carrying the levers 3 of the comb discs and bringing them into an optimal position for fruit catching.

For the support beam 1.1 and along its length, steel sleeves 1.2 are inseparably attached by welding, and their number is greater and depends on the required length of the fruit catch zone. Bronze sleeves 1.3 are pressed into the steel sleeves 1.2 and serve as a contact surface between the steel sleeve 1.2 and the axle 3.2 of the comb disc lever to reduce material wear during the rotation of lever 3 of the comb disc. At one end of the support beam 1.1, a connector 1.4 is attached to supply air into the air channel 1.8, which is designed onto beam 1.1, preferably on its lower side, to form air cushions at the discs with combs. Also, at the ends of the support beam 1.1, support eyelets 1.5, tensioner eyelets 1.6, and tensioning screw eyelets 1.7 are placed, as shown in FIG. 3. Instead of being firmly attached to the machine, the support beams 1.1 can be elastically supported on it via springs 1.9 and eyelets 1.5, allowing for vertical movement of the ends of the beam 1.1 in approximately a vertical direction. It is preferable that the support is done by a pair of coil springs at each end of the support beam.

The spring tensioner 2 is made from an L-profile 2.1 and is connected to the support beam 1.1 using tensioner eyelet 1.6 and screw 2.3. Holes are made on the L-profile 2.1 for tensioning, through which the tension springs 2.2 are attached. At one end of the support beam 1.1, a tensioning eyelet 1.7 is attached, which is connected to the L-profile 2.1 via a tensioning screw 2.4 and linearly moves the L-profile 2.1, increasing or decreasing the tension of springs 2.2, which return the comb discs' levers 3 to the neutral position, shown in FIG. 4.

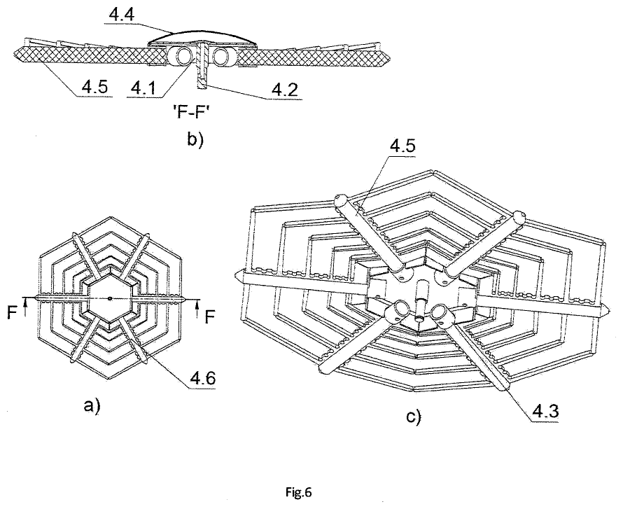

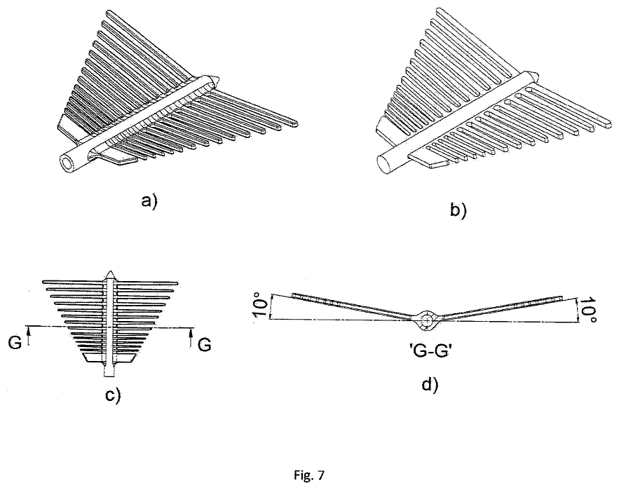

The lever 3 of the comb disc consists of the body 3.1 of the lever, to which an axle 3.2 of the lever is inseparably attached at one end, a lever limiter 3.3 made perpendicular to the lever from its lower side, and an eyelet 3.5 of the lever, which is used for attaching the tension spring 2.2, while at the other end, opposite from the axle 3.2 of the lever, a sleeve 3.4 of the lever is placed. The axle 3.2 of the lever is inserted into the steel sleeve 1.2, which is inseparably attached to the support beam 1.1, while the limiter 3.3 of the lever rests against the side of the support beam 1.1 itself and limits the rotation of the lever in two positions. Due to the rotated positions of the beams 1.1, the two opposite rows of levers 3 form an angle such that their inner ends are directed upwards and outwards, for not only the avoidance of comb discs colliding and their overlap but also the collection of fruits in the tunnel side area, e.g., via a belt conveyor. The initial or zero position of the limiter 3.3 of the lever implies the position of disc 4 when it does not come into contact with the tree and branches. When contact with the tree and branches is made, lever 3 of the comb discs rotates by an angle to allow a branch or other obstacle to pass and to place the comb disc into the most favorable position for catching the picked fruits. The second position of the limiter 3.3 of the lever ensures the maximum rotation of lever 3, which is connected via limiter 3.3 to spring 2.2, and ensures the return of the lever to the initial position. A pivot 4.2 for rotation is inserted into sleeve 3.4 of the lever, shown in FIG. 5.

The rotating disc 4 with combs consists of the body 4.1 of the disc, which is made in the shape of an octagon, hexagon, or circle, and to which a pivot 4.2 for disc rotation is inseparably attached, while the other end of the pivot 4.2 is inserted into sleeve 3.4 of the lever. The pivot 4.2 for disc rotation enables free rotation of the disc in sleeve 3.4 of the lever. The air coming from the air connector 1.4 via channel 1.8 on the support beam 1.1 passes through the axle 3.2 of the lever, the body 3.1 of the lever, sleeve 3.4 of the lever, and further through the central channel on the pivot 4.2 to bring air to the upper surface of the disc or the catch cushion 4.4 made of rubber. The body 4.1 of the disc is wrapped around the rim with a neoprene or silicone rubber membrane, which becomes fluidized by bringing air through the central channel of the pivot 4.2 for disc rotation, forming a thin layer of air between the body 4.1 of the disc and the neoprene rubber, thereby creating the catch cushion 4.4 that provides a soft catch of the fruit. The free rotation of disc 4 brings the fruit to the transport system of the machine and provides the most favorable position for the entry of fingers 4.5 around the tree and branches. Sleeves 4.3 for fingers are inseparably attached around the rim of the body 4.1 and serve for attaching fingers 4.5. Fingers 4.5 are inserted into sleeves 4.3 and can be fastened with screws passed through coaxial holes made transversely to finger 4.5 and sleeve 4.3, thus preventing their rotation or falling out of sleeve 4.3. Fingers 4.5 are circularly distributed around the rim of the disc body 4.1, and their number depends on the shape of body 4.1 of the disc, which also determines the angle between them, 360/n, as shown in FIG. 6.

Fingers 4.5 can be cast together with combs 4.6, as shown in FIG. 7a, or they can have a cylindrical cross-section of a certain length with side channels made for attaching combs 4.6 at a certain angle so that combs 4.6 are directed upwards, most preferably at an angle of 10 degrees to retain the fruit, as shown in FIG. 7b, c, d.

Combs 4.6 are made of polyurethane or another soft rubber and close the space between two adjacent fingers 4.5. The distance between combs 4.6 and their length determine the stiffness or flexibility of the combs, which is crucial in closing the space around the plant and fruit spillage reduction. To prevent overlapping and collision of combs 4.6 of adjacent fingers 4.5, combs 4.6 are longest at the outer end of each finger 4.5, and then their length gradually decreases towards the inner end of the finger.

The functioning of the comb disc system for the soft catching of fruits in a mechanized fruit picker according to the invention is simple and clearly follows from the detailed description and figures of the drawing. Namely, the air coming from connector 1.4 passes through air channel 1.8 placed on the support beam 1.1, preferably on its lower side, then through axle 3.2 of the lever inserted into the steel sleeve 1.2, then through body 3.1 of the lever and sleeve 3.4 of the lever, and further passes through pivot 4.2 for disc rotation, forming a thin layer of air between body 4.1 of the disc and the membrane, thereby creating a catch cushion 4.4 for soft catch of the fruit.

1. A comb disc system for the soft catching of fruits in a mechanized fruit picker includes rotating levers (3) of comb discs arranged in a row at an angle so that their inner ends are directed upwards and outwards, and the outer ends are rotatably connected to two supporting beams (1.1) of the comb disc on which the levers (3) are elastically supported, where the supporting beams (1.1) are essentially parallel and opposite, suitable for placement on each side of the tunnel of the mechanized fruit picker, characterized in that at the inner end of each lever (3), in the plane of its rotation, a body (4.1) of the disc is rotatably connected, to which radially oriented fingers (4.5) are firmly attached by their inner ends around the rim, and flexible combs (4.6) are firmly attached on each side of the finger (4.5), turned upwards relative to the longitudinal axis of the finger (4.5), where at least some combs (4.6) are partially overlapping with at least some combs (4.6) of adjacent comb discs, and where the combs (4.6) at the outer end of each finger (4.5) are the longest and then progressively shorter towards the inner end of each finger (4.5).

2. The system according to claim 1, characterized in that the ends of the beam (1.1) are bent over springs (1.9), the lower ends of which are supported on eyelets (1.5) suitable for firm attachment to the mechanized fruit picker.

3. The system according to claim 1, characterized in that the outer end of each lever (3) is extended over the beam (1.1) and has a tension spring (2.2) for elastically supporting the lever (3), where the tension spring (2.2) is rotatably connected to the outer side of the support beam (1.1) and on the other side is rotatably connected to the extension of the lever (3) through an eyelet (3.5).

4. The system according to claim 1, is characterized in that at the outer ends of the levers (3), perpendicular to the plane of rotation of the lever, limiters (3.3) of the levers are made for supporting the levers (3) on the support beam (1.1) in two end positions of the lever (3).

5. The system according to claim 3 is characterized in that the springs (2.2) are attached to the outer side of the beam (1.1) via a tensioning profile (2.1) on which slotted holes are drilled, through which a profile (2.1) is firmly attached to the beam (1.1) with screws (2.3) passed through eyelets (1.6), and that at one end it is connected with a screw (2.4) to an eyelet (1.7) of the tensioning screw firmly attached to the outer side of the beam (1.1).

6. The system according to claim 1, is characterized in that a membrane is attached to the rim of the body (4.1) of the disc from its upper side, which forms a catch cushion with pressurized air.

7. The system according to claim 6 is characterized in that a central opening is made in the middle of the body (4.1) of the disc, which on its lower side is connected with a hollow pivot (4.2) inseparably attached to the body (4.1) of the disc, inside which a channel is made for attaching to a connector (1.4) for compressed air on the picker machine.

8. The system according to claim 7 is characterized in that the hollow pivot (4.2) is connected with the connector (1.4) for compressed air on the picker machine via an air channel (1.8) placed on the support beam (1.1), connected to a hollow axle (3.2) of the lever (3), which is connected with the hollow section of the lever body (3.1).

9. The system according to claim 2, is characterized in that the finger (4.5) is attached to the body (4.1) of the disc using a sleeve (4.3) for fingers into which it is inserted and to which it is fastened by the screw passed through coaxial holes made transversely to the finger (4.5) and sleeve (4.3), where the sleeves (4.3) are radially, inseparably attached around the rim of the disc body (4.1).

10. The system according to claim 1, is characterized in that the finger (4.5) is integrally made with combs (4.6).

11. The system according to claim 1, is characterized in that along the two opposite side edges of the finger (4.5), channels are made in which the combs (4.6) are secured at one of their ends.

12. The system according to claim 1, is characterized in that the body (4.1) of the disc has a polygonal shape.

13. The system according to claim 1, is characterized in that the body (4.1) of the disc is circular in shape.
